(19) United States
(12) Patent Application Publication
(10) Pub. No.: US 2023/0322545 A1
(43) Pub. Date: Oct. 12, 2023

(54) VEHICLE CONVEYANCE MANAGEMENT SYSTEM AND VEHICLE CONVEYANCE MANAGEMENT METHOD AND STORAGE MEDIUM

(71) Applicant: TOYOTA JIDOSHA KABUSHIKI KAISHA, Aichi-ken (JP)

(72) Inventors: Masayuki ITOH, Nagoya-shi (JP); Iwao MAEDA, Nagoya-shi (JP); Tatsuya SUGANO, Susono-shi (JP); Norinao WATANABE, Susono-shi (JP); Yutaka NAKAMURA, Susono-shi (JP); Yoshikazu JIKUHARA, Susono-shi (JP); Yuki NISHIKAWA, Susono-shi (JP)

(21) Appl. No.: 18/297,654

(22) Filed: Apr. 10, 2023

(30) Foreign Application Priority Data
Apr. 11, 2022 (JP) 2022-065135

(51) Int. Cl. B67D 7/04; B60L 53/36; B60L 53/62

(52) U.S. Cl. CPC B67D 7/0401; B60L 53/36; B60L 53/62; B60L 2240/622; B67D 2007/0465; B67D 2007/0403

(57) ABSTRACT

In the automated parking lot, a plurality of facilities having respectively different functions enabling automated driving vehicles to be restored to a runnable state in accordance with the causes of disablement acquired from the automated driving vehicles when the automated driving vehicle becomes disabled and stop are provided. When the automated driving vehicle becomes disabled and stops in the automated parking lot, a facility having a function enabling the automated driving vehicle to be restored to a runnable state for the cause of disablement of that automated driving vehicle is selected from the plurality of facilities and the automated driving vehicle disabled is conveyed by the vehicle conveyance robot to the selected facility.

### FIELD

The present invention relates to a vehicle conveyance management system and a vehicle conveyance management method and storage medium.

### BACKGROUND ART

Known in the art is a method for operating an automated towing robot designed to tow a broken down automated driving vehicle to a preset location using a standing by automated towing robot when, for example, an automated driving vehicle breaks down on a vehicle parking lot (for example, see U.S. Patent Application Publication No. 2016/0115702).

### SUMMARY

In this regard, in this case, for example, when the automated driving vehicle becomes disabled and stops due to a shortage of drive energy of the automated driving vehicle, it is preferable to tow the automated driving vehicle by the automated towing robot to a facility able to supply drive energy. When the automated driving vehicle becomes disabled and stops due to trouble in vehicle equipment, it is preferable to tow the automated driving vehicle by the automated towing robot to a facility able to restore the vehicle functions. That is, when the automated driving vehicle becomes disabled and stops, it is desirable to tow it by the automated towing robot to a facility having a function enabling the vehicle to be restored to a runnable state for the cause of disablement of the automated driving vehicle.

However, the above patent literature does not at all disclose such a thing.

Therefore, according to the present invention, there is provided a vehicle conveyance management system comprising:
a vehicle conveyance robot which is automatically driven for conveying a vehicle,
a management server for managing operation of the vehicle conveyance robot, and
a plurality of facilities having respectively different functions enabling a vehicle to be restored to a runnable state in accordance with a cause of disablement when the vehicle becomes disabled and stops, wherein
when the vehicle becomes disabled and stops, the cause of disablement is acquired by the management server, the facility having a function enabling the vehicle to be restored to a runnable state for the acquired cause of disablement is selected from the plurality of facilities, and the disabled vehicle is conveyed by the vehicle conveyance robot to the selected facility.

Furthermore, according to the present invention, there is provided a vehicle conveyance management method comprising:
preparing a plurality of facilities having respectively different functions enabling a vehicle to be restored to a runnable state in accordance with a cause of disablement when the vehicle becomes disabled and stops,
acquiring the cause of disablement when the vehicle becomes disabled and stops,
selecting a facility having a function enabling the vehicle to be restored to a runnable state for the acquired cause of disablement from the plurality of facilities, and making the disabled vehicle be conveyed by a vehicle conveyance robot to the selected facility.

Furthermore, according to the present invention, there is provided a non-transitory computer-readable storage medium storing a program used for control of a vehicle conveyance management system comprising a plurality of facilities having respectively different functions enabling a vehicle to be restored to a runnable state in accordance with a cause of disablement when a vehicle becomes disabled and stops, the program causing a computer to:
acquire the cause of disablement when a vehicle becomes disabled and stops,
select a facility having a function enabling the vehicle to be restored to a runnable state for the acquired cause of disablement from the plurality of facilities, and
make the disabled vehicle be conveyed by a vehicle conveyance robot to the selected facility.

According to the present invention, it becomes possible to convey the vehicle to a facility having a function enabling the vehicle to be restored to a runnable state when the vehicle becomes disabled.

### BRIEF DESCRIPTION OF DRAWINGS

FIG. 1 is a plan view schematically showing an automated parking lot.

FIG. 2 is a plan view schematically showing an automated parking lot.

FIG. 3 is a plan view schematically showing an automated parking lot.

FIG. 4 is a view schematically showing a lot entry/exit management server.

FIG. 5 is a view schematically showing an automated driving vehicle.

FIG. 6A, FIG. 6B, and FIG. 6C are views schematically showing a vehicle conveyance robot 11.

FIG. 7A and FIG. 7B are views for explaining the work of loading a manual driving vehicle at a vehicle conveyance robot.

FIG. 8A and FIG. 8B are views for explaining the work of unloading a manual driving vehicle from a vehicle conveyance robot.

FIG. 9 is a view schematically showing a conveyance robot head of a vehicle conveyance robot.

FIG. 10 is a view showing current states of a vehicle conveyance robot.

FIG. 11 is a view showing a list of current states of a vehicle conveyance robot.

FIG. 12 is a flow chart for managing a vehicle conveyance robot.

FIG. 13 is a flow chart for control of operation of a vehicle conveyance robot.

FIG. 14 is a flow chart for lot entry/exit management control.

FIG. 15 is a flow chart for control of operation of a vehicle.

FIG. 16 is a flow chart for performing a diagnosis of vehicle functions.

FIG. 17 is a flow chart for performing processing for dealing with a disabled vehicle.

### DESCRIPTION OF EMBODIMENTS

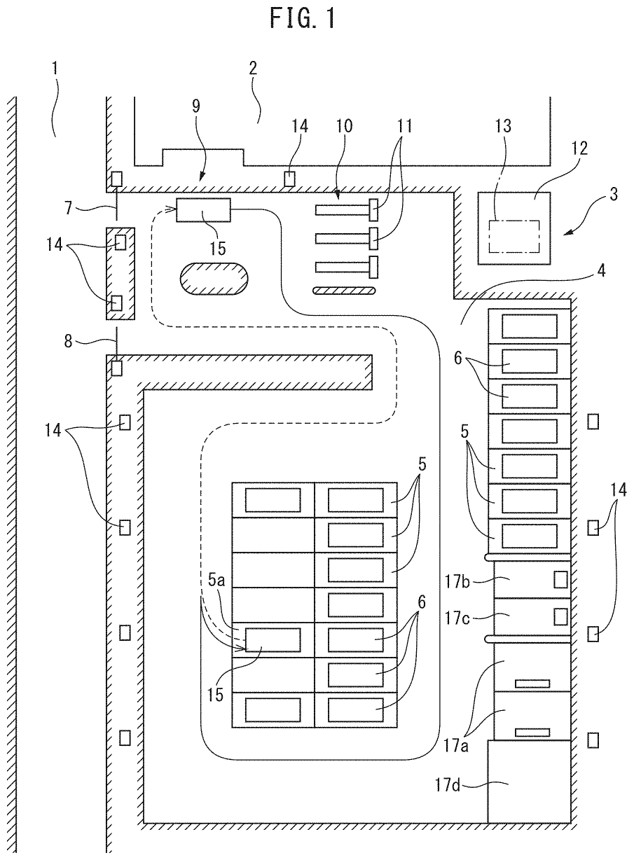

FIG. 1 to FIG. 3 are plan views schematically showing the same automated parking lot. Referring to FIG. 1 to FIG. 3, 1 indicates a road, 2 a department store or other facility, 3 an automated parking lot, 4 a parking lot region of the automated parking lot 3, 5 a plurality of parking spaces set inside the parking lot region 4, 6 vehicles already parked at the parking spaces 5, 7 an entry gate to the parking lot region 4, 8 an exit gate from the parking lot region 4, 9 a passenger platform, 10 a standby location of vehicle conveyance robots for conveying a vehicle, 11 a large number of vehicle conveyance robots standing by at the standby location 10, and 12 a parking management facility. Inside this parking management facility 12, a lot entry/exit management server 13 is installed for managing lot entry and lot exit.

Further, as shown in FIG. 1 to FIG. 3, at the automated parking lot 3, a large number of infrastructure sensors 14 are arranged for identifying vehicles entering the automated parking lot 3 and vehicles exiting the automated parking lot 3, detecting fixed structures and moving objects inside the parking lot region 4, and detecting the parked states of vehicles in the parking lot region 4. As these infrastructure sensors 14, cameras or laser sensors etc. may be used. In this case, for example, if cameras are used as the infrastructure sensors 14, the image signals captured by the infrastructure sensors 14 are sent to the lot entry/exit management server 13 installed in the parking management facility 12.

At the automated parking lot 3 shown in FIG. 1 to FIG. 3, when there is a request for lot entry for the automated driving vehicle, after the passengers are dropped off from the automated driving vehicle at the passenger platform 9, the automated driving vehicle is made to move by automated driving to the empty parking space 5. When there is a request for lot exit for the automated driving vehicle, the automated driving vehicle parked at a parking space 5 is made to move by automated driving to the passenger platform 9. On the other hand, when there is a request for lot entry for the manual driving vehicle, after the passengers exit the manual driving vehicle at the passenger platform 9, the manual driving vehicle is conveyed by the automated driving vehicle conveyance robot 11 to the empty parking space 5, while when there is a request for lot exit for the manual driving vehicle, the manual driving vehicle parked at the parking space 5 is conveyed by the automated driving vehicle conveyance robot 11 to the passenger platform 9.

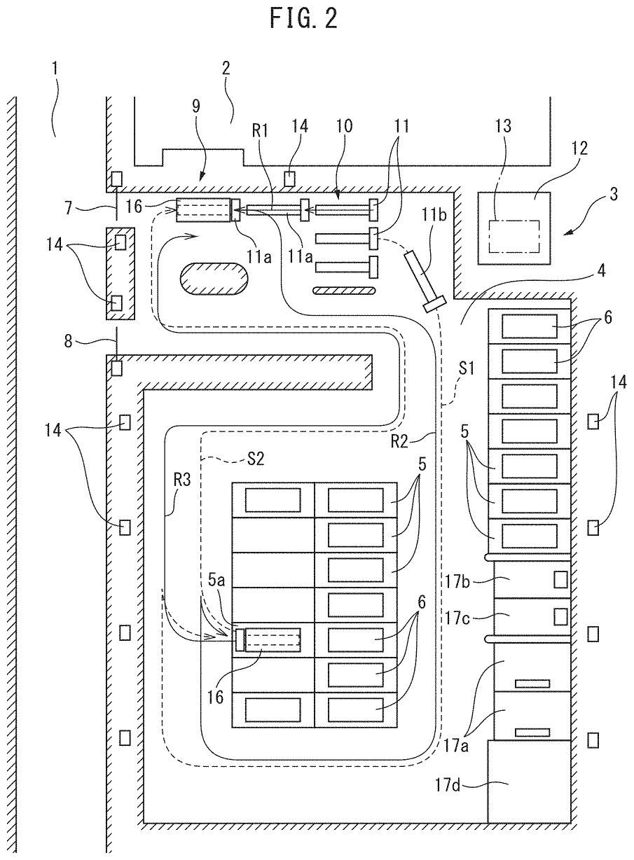

In this way, at the automated parking lot 3 shown in FIG. 1 to FIG. 3, an automated parking service, that is, an auto valet parking service, able to automatically park the manual driving vehicle and automated driving vehicle, is performed. In FIG. 1, an example of a lot entry/exit action in the case where the parking space 5 designated for the automated driving vehicle 15 for which lot entry is requested was the parking space 5a is schematically shown by the arrow, while in FIG. 2, an example of a lot entry/exit action in the case where the parking space 5 designated for the manual driving vehicle 16 for which lot entry is requested was the parking space 5a is schematically shown by the arrow.

That is, at the time of lot entry of the automated driving vehicle 15, if the automated driving vehicle 15 arrives at the passenger platform 9 and the passengers exit the automated driving vehicle 15, the automated driving vehicle 15 is made to move by automated driving to the parking space 5a as shown by the solid arrow in FIG. 1 and is parked at the parking space 5a. On the other hand, at the time of lot exit of the automated driving vehicle 15, the automated driving vehicle 15 parked at the parking space 5a is made to move by automated driving from the parking space 5a to the passenger platform 9 as shown by the broken arrow in FIG. 1.

On the other hand, at the time of lot entry of the manual driving vehicle 16, if the manual driving vehicle 16 arrives at the passenger platform 9 and the passengers exit the manual driving vehicle 16, as shown by the solid arrow R1 in FIG. 2, one vehicle conveyance robot 11a of the vehicle conveyance robots 11 standing by at the standby location 10 is made to move by automated driving toward the manual driving vehicle 16 and the manual driving vehicle 16 stopped at the passenger platform 9 is loaded on the vehicle conveyance robot 11a. Next, the vehicle conveyance robot 11a carrying the manual driving vehicle 16 is made to move by automated driving to the parking space 5a as shown by the solid arrow R1 in FIG. 2. At the parking space 5a, the carried manual driving vehicle 16 is unloaded from the vehicle conveyance robot 11a. Next, the empty vehicle conveyance robot 11a which unloaded the manual driving vehicle 16 is returned by automated driving to the standby location 10 as shown by the solid arrow R3 in FIG. 1.

Further, at the time of lot exit of the manual driving vehicle 16, one vehicle conveyance robot 11b of the vehicle conveyance robots 11 standing by at the standby location 10 is made to move by automated driving toward the parking space 5a as shown by the broken arrow S1 in FIG. 2 and the manual driving vehicle 16 stopped at the parking space 5a is loaded on the vehicle conveyance robot 11b. Next, the vehicle conveyance robot 11b carrying the manual driving vehicle 16 is made to move by automated driving to the passenger platform 9 as shown by the broken arrow S2 in FIG. 2. At the passenger platform 9, the carried manual driving vehicle 16 is unloaded from the vehicle conveyance robot 11b. Next, the empty vehicle conveyance robot 11b which unloaded the manual driving vehicle 16 is returned by automated driving to the standby location 10.

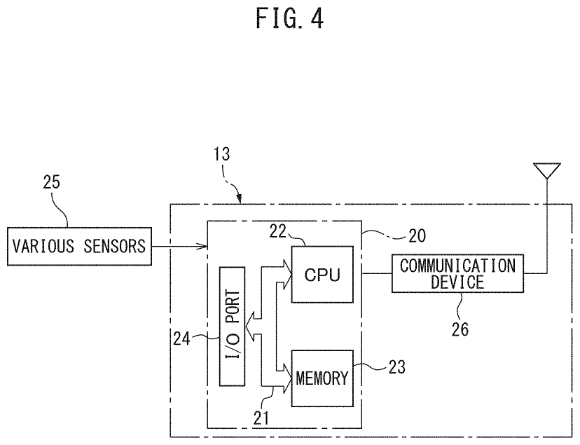

Next, the lot entry/exit management server 13, automated driving vehicle 15, and vehicle conveyance robot 11 shown in FIG. 1 and FIG. 2 will be explained in that order. FIG. 4 shows the lot entry/exit management server 13 shown in FIG. 1. Referring to FIG. 4, an electronic control unit 20 is provided inside the lot entry/exit management server 13. This electronic control unit 20 is comprised of a digital computer provided with a CPU (microprocessor) 22, a memory 23 comprised of a ROM and RAM, and an input/output port 24, which are connected with each other by a bidirectional bus 21. As shown in FIG. 4, the detection signals of various sensors 25 including the infrastructure sensors 14 are input into the electronic control unit 20. Further, the map data of the parking lot region 4 is stored inside the memory 23 of the electronic control unit 20.

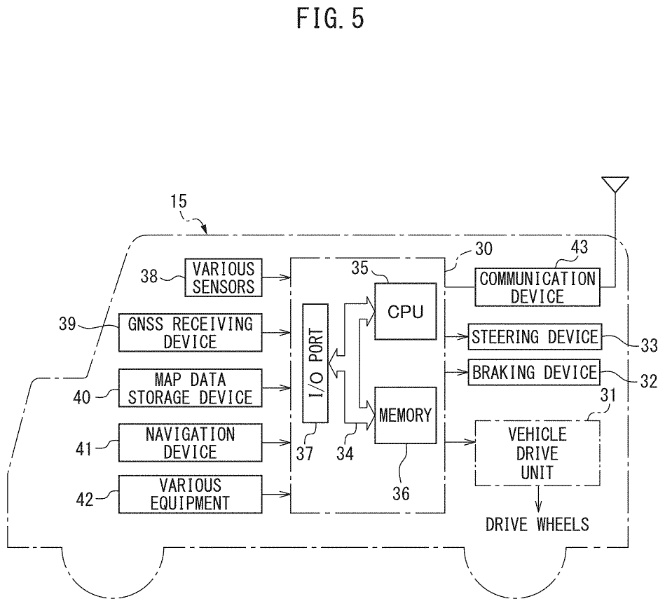

FIG. 5 schematically shows one example of the automated driving vehicle 15 shown in FIG. 1. Referring to FIG. 5, 30 indicates an electronic control unit mounted in the automated driving vehicle 15, 31 a vehicle drive unit comprised of for example an electric motor for applying drive force to the drive wheels of the automated driving vehicle 15, 32 is a braking device for braking the automated driving vehicle 15, and 33 is a steering device for steering the automated driving vehicle 15. As shown in FIG. 5, the electronic control unit 30 is comprised of a digital computer provided with a CPU (microprocessor) 35, a memory 36 comprised of a ROM and RAM, and an input/output port 37, which are connected with each other by a bidirectional bus 34. On the other hand, various sensors 38 necessary for the automated driving vehicle 15 to be automatically driven, that is, sensors for detecting the state of the automated driving vehicle 15 and periphery detection sensors for detecting the periphery of the automated driving vehicle 15 are attached to the automated driving vehicle 15. In this case, as the sensors for detecting the state of the automated driving vehicle 15, an acceleration sensor, speed sensor, and azimuth sensor are used. As periphery detection sensors for detecting the periphery of the automated driving vehicle 15, vehicle-mounted cameras for capturing the front, sides, and rear of the vehicle conveyance robot 11, LIDAR, radar, etc. are used.

Further, the automated driving vehicle 15 is provided with a GNSS (Global Navigation Satellite System) receiving device 39, map data storage device 40, navigation device 41, and various equipment 42. The GNSS receiving device 39 can detect the current position of the automated driving vehicle 15 (for example, the latitude and longitude of the automated driving vehicle 15) based on information obtained from a plurality of satellites. Therefore, it is possible to acquire the current position of the automated driving vehicle 15 by this GNSS receiving device 39. As this GNSS receiving device 39, for example, a GPS receiving device is used. On the other hand, in the map data storage device 40, map data etc. required for the automated driving vehicle 15 to be automatically driven are stored. These various sensors 38, GNSS receiving device 39, map data storage device 40, navigation device 41, and various equipment 42 are connected to the electronic control unit 30. Further, a communication device 43 for communicating with the lot entry/exit management server 13 is mounted at the automated driving vehicle 15 and, as shown in FIG. 4, a communication device 26 for communicating with the automated driving vehicle 15 is provided inside the lot entry/exit management server 13.

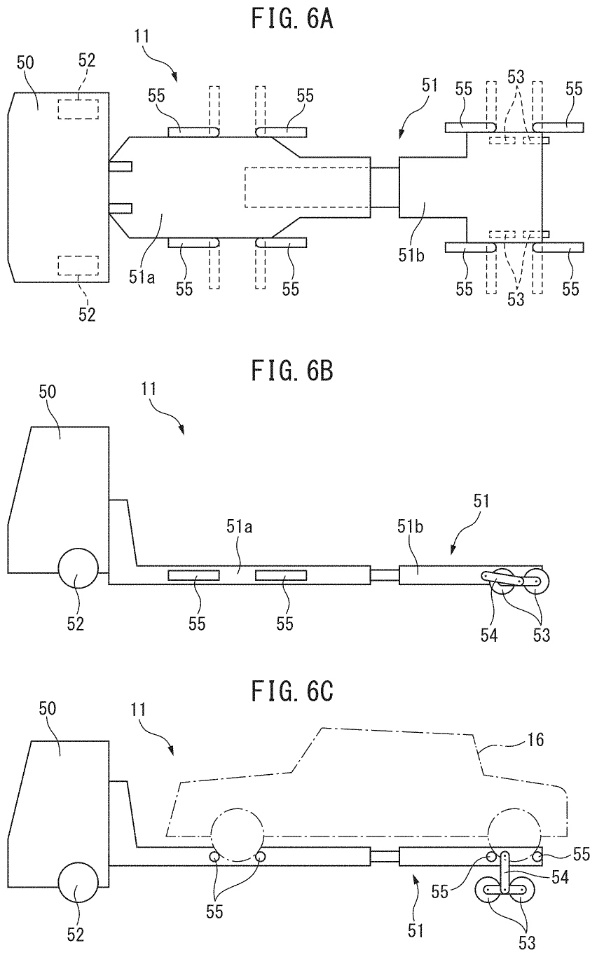

FIG. 6A shows a plan view schematically showing the vehicle conveyance robot 11 shown in FIG. 2, while FIG. 6B and FIG. 6C show side views of the vehicle conveyance robot 11 shown in FIG. 6A. Referring to FIG. 6A, FIG. 6B, and FIG. 6C, 50 indicates a conveyance robot head, 51 a bed part connected to the conveyance robot head 50 and able to ascend or descend in the vertical direction, 52 front wheels comprised of drive wheels, 53 rear wheels comprised of driven wheels, and 54 a lift link device arranged between the rear wheels 53 and the bed part 51. The bed part 51 is comprised of a front bed part 51a and a rear bed part 51b slidingly coupled with the front bed part 51a.

As shown in FIG. 6A, at both sides of the front bed part 51a and the rear bed part 51b, pairs of wheel support arms 55 able to swing 90 degrees from the retracted positions shown by the solid lines to the projecting positions shown by the broken lines are arranged. The swinging motion of the pairs of arms 55 and the sliding motion of the rear bed part 51b with respect to the front bed part 51a are performed by hydraulic cylinders or electric motors. On the other hand, the bed part 51 is controlled to rise or descend between the descended position shown in FIG. 6B and the ascended position shown in FIG. 6C. In this case, at the connecting part of the front bed part 51a and the conveyance robot head 50, a hydraulic cylinder or electric motor for bed lift control is provided. The bed part 51 is controlled to rise or descend by the hydraulic cylinder or electric motor for bed lift control and the hydraulic cylinder or electric motor for driving the lift link device 54.

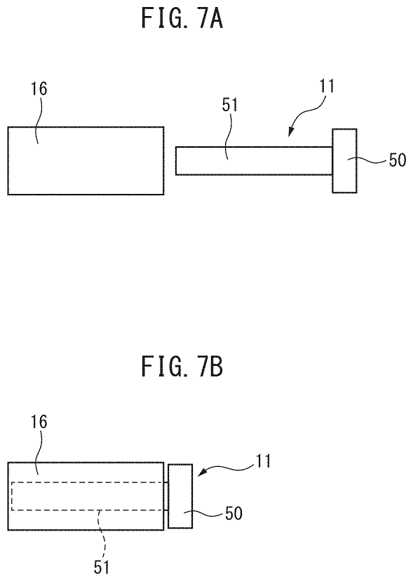

When loading the manual driving vehicle 16 on the vehicle conveyance robot 11, as shown by the solid line in FIG. 6A, the pairs of arms 55 are held at the retracted positions and, as shown in FIG. 6B, the bed part 51 is held at the descended position. Next, in such a state, the vehicle conveyance robot 11, as shown in FIG. 7A, is made to move to the vehicle loading ready position where the bed part 51 is aligned with the longitudinal axis of the manual driving vehicle 16. Next, the vehicle conveyance robot 11 is made to retract and, as shown in FIG. 7B, the bed part 51 enters below the manual driving vehicle 16. Next, all of the arms 55 are made to swing to the projected positions, then the bed part 51 is made to rise. If the bed part 51 is made to rise, all of the wheels of the manual driving vehicle 16 are supported by the corresponding pairs of arms 55. Due to this, the manual driving vehicle 16 is loaded on the vehicle conveyance robot 11. Note that, the interval between the front bed part 51a and the rear bed part 51b is adjusted in accordance with the wheel base of the loaded manual driving vehicle 16.

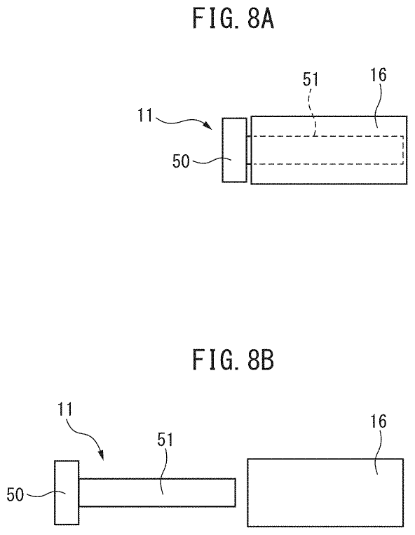

On the other hand, when unloading the manual driving vehicle 16 from the vehicle conveyance robot 11, the vehicle conveyance robot 11 is made to move to the unloading position. This time is shown in FIG. 8A. Next, the bed part 51 is made to descend and the carried manual driving vehicle 16 is lowered to the ground surface. Next, all of the arms 55 are made to swing to the retracted positions. Next, the vehicle conveyance robot 11 is made to advance in the state with the bed part 51 aligned with the longitudinal axis of the manual driving vehicle 16 and, as shown in FIG. 8B, is made to move to the running ready position where the bed part 51 has completely pulled out from below the manual driving vehicle 16.

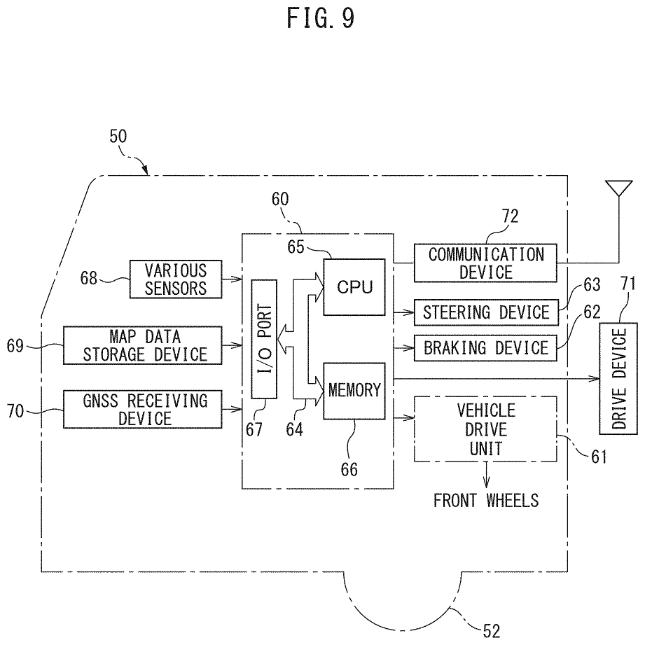

FIG. 9 schematically shows one example of the conveyance robot head 50 of the vehicle conveyance robot 11 shown in FIG. 6A, FIG. 6B, and FIG. 6C. Referring to FIG. 9, 60 indicates an electronic control unit mounted inside the conveyance robot head 50, 61 a vehicle drive unit comprised of, for example, an electric motor for applying drive force to the front wheels 52 of the vehicle conveyance robot 11, 62 is a braking device for braking the vehicle conveyance robot 11, and 63 is a steering device for steering the front wheels 52. As shown in FIG. 9, the electronic control unit 60 is comprised of a digital computer provided with a CPU (microprocessor) 65, a memory 66 comprised of a ROM and RAM, and an input/output port 67, which are connected with each other by a bidirectional bus 64. On the other hand, the vehicle conveyance robot 11 has various sensors 68 required for the vehicle conveyance robot 11 to be automatically driven, that is, sensors for detecting the state of the vehicle conveyance robot 11 and periphery detection sensors for detecting the periphery of the vehicle conveyance robot 11, arranged at it. In this case, as the sensors for detecting the state of the vehicle conveyance robot 11, an acceleration sensor, speed sensor, and azimuth sensor are used. As periphery detection sensors for detecting the periphery of the vehicle conveyance robot 11, vehicle-mounted cameras for capturing the front, sides, and rear of the vehicle conveyance robot 11, LIDAR, radar, etc. are used.

Further, the conveyance robot head 50 is provided with a map data storage device 69 and GNSS receiving device 70. This GNSS receiving device 70 can detect the current position of the vehicle conveyance robot 11 (for example, the latitude and longitude of the vehicle conveyance robot 11) based on information obtained from a plurality of satellites. In the map data storage device 69, map data etc. of the parking lot region 4 required for the vehicle conveyance robot 11 to be automatically driven are stored. These various sensors 68, map data storage device 69, and GNSS receiving device 70 are connected to the electronic control unit 60. Further, the hydraulic cylinder or electric motor or other drive device 71 for control of lift of the bed part 51 and control of swing of the arms 55 are connected to the electronic control unit 60. Further, a communication device 72 is carried on the conveyance robot head 50 for communicating with the lot entry/exit management server 13.

Next, referring to FIG. 1, the lot entry/exit work of the automated driving vehicle 15 at the automated parking lot 3 will be explained in a bit more detail. In an embodiment of the present invention, when a user utilizing the automated parking service parks his or her own automated driving vehicle 15 at the automated parking lot 3, for example, when the automated driving vehicle 15 reaches the passenger platform 9, for example, the lot entry request is sent together with the vehicle ID for identifying the vehicle from the mobile terminal of the user through the communication network to the lot entry/exit management server 13. If the lot entry/exit management server 13 receives the lot entry request, the lot entry/exit management server 13 sets the running route of the vehicle enabling the vehicle to reach the set parking space 5a from the passenger platform 9 as shown by the solid arrow in FIG. 1 without contacting other vehicles or pedestrians and sends this set running route to the automated driving vehicle 15 of the user. If the automated driving vehicle 15 of the user receives the set running route from the lot entry/exit management server 13, the automated driving vehicle 15 of the user is made to move along this set running route by automated driving from the passenger platform 9 to the empty parking space 5a.

On the other hand, the same is true for when the user makes the automated driving vehicle 15 exit the automated parking lot 3. For example, if the user reaches the passenger platform 9, the lot exit request is sent together with the vehicle ID for identifying the vehicle from the mobile terminal of the user through the communication network to the lot entry/exit management server 13. If the lot entry/exit management server 13 receives the lot exit request, the lot entry/exit management server 13 sets the running route of the vehicle enabling the automated driving vehicle 15 to reach the passenger platform 9 from the space 5a parked at without contacting other vehicles or pedestrians and sends this set running route to the automated driving vehicle 15 of the user. If the automated driving vehicle 15 of the user receives the set running route from the lot entry/exit management server 13, the automated driving vehicle 15 of the user is made to move along this set running route from the space 5a parked at by automated driving to the passenger platform 9.

Next, referring to FIG. 2, the work for lot entry and exit of the manual driving vehicle 16 at the automated parking lot 3 will be explained in a bit more detail. In the embodiment of the present invention, when a user utilizing the automated parking service makes his or her own manual driving vehicle 16 park at the automated parking lot 3, for example, when the manual driving vehicle 16 reaches the passenger platform 9, for example, the lot entry request is sent together with the vehicle ID for identifying the vehicle from the mobile terminal of the user through the communication network to the lot entry/exit management server 13. If the lot entry/exit management server 13 receives the lot entry request, the lot entry/exit management server 13 makes the vehicle conveyance robot 11 move by automated driving to the passenger platform 9, loads the manual driving vehicle 16 stopped at the passenger platform 9 onto the vehicle conveyance robot 11, then makes the vehicle conveyance robot 11 carrying the manual driving vehicle 16 move from the passenger platform 9 to the set parking space 5a as shown by the broken arrow in FIG. 2.

On the other hand, the same is true for when the user makes the manual driving vehicle 16 exit from the automated parking lot 3. For example, if the user reaches the passenger platform 9, he or she sends the lot exit request together with the vehicle ID for identifying the vehicle from the mobile terminal of the user through the communication network to the lot entry/exit management server 13. If the lot entry/exit management server 13 receives the lot exit request, the lot entry/exit management server 13 makes the vehicle conveyance robot 11 move by automated driving to the parking space 5a, loads the manual driving vehicle 16 parked at the parking space 5a onto the vehicle conveyance robot 11, then makes the vehicle conveyance robot 11 carrying the manual driving vehicle 16 move to the passenger platform 9 as shown by the solid arrow in FIG. 2.

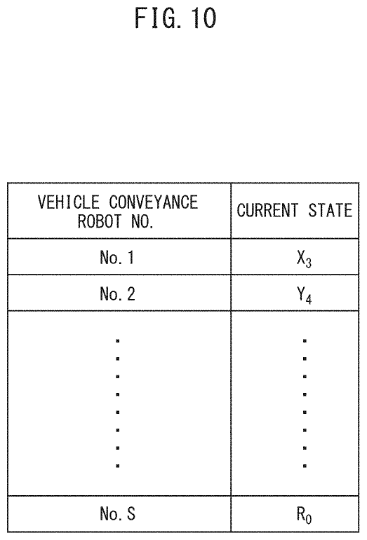

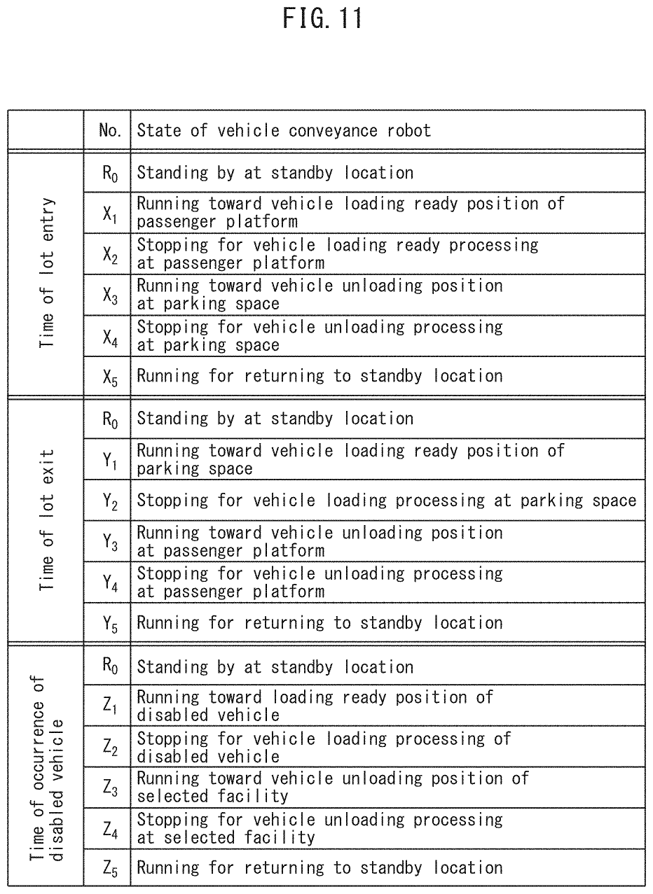

In this way, in the embodiment of the present invention, the vehicle conveyance robots 11 are managed by the lot entry/exit management server 13. Therefore, first, management of the vehicle conveyance robots 11 by the lot entry/exit management server 13 will be explained. At the lot entry/exit management server 13, the current states Xi (i=1, 2 . . . 5), Yi (i=1, 2 . . . 5), R₀ of all of the No. 1 to No. S vehicle conveyance robots 11 present in the automated parking lot 3 such as shown in FIG. 10 are constantly acquired based on the image signals captured by the infrastructure sensors 14 or the position information of the vehicle conveyance robots 11 received from the vehicle conveyance robots 11. In the list of FIG. 11, the contents of the states Xi, Yi, R₀ are shown divided between the states at the time of lot entry and the states at the time of lot exit.

That is, as shown in FIG. 11, at the time of lot entry of the manual driving vehicle 16, R₀ shows the state of standing by at the standby location 10, X₁ shows the state of running toward the vehicle loading ready position of the passenger platform 9 (FIG. 7A), X₂ shows the state of stopping for processing for loading the vehicle at the passenger platform 9, X₃ shows the state of running toward the position for unloading the vehicle at the parking space 5, X₄ shows the state of stopping for processing for unloading the vehicle at the parking space 5, and X₅ shows the state of running for returning to the standby location 10. Further, at the time of lot exit of the manual driving vehicle 16, R₀ shows the state of standing by at the standby location Y₁ shows the state of running toward the vehicle loading ready position of the parking space 5 (FIG. 7A), Y₂ shows the state of stopping for processing for loading the vehicle at the parking space 5, Y₃ shows the state of running toward the position for unloading the vehicle of the passenger platform 9, Y₄ shows the state of stopping for processing for unloading the vehicle at the passenger platform 9, and Y₅ shows the state of running for returning to the standby location 10.

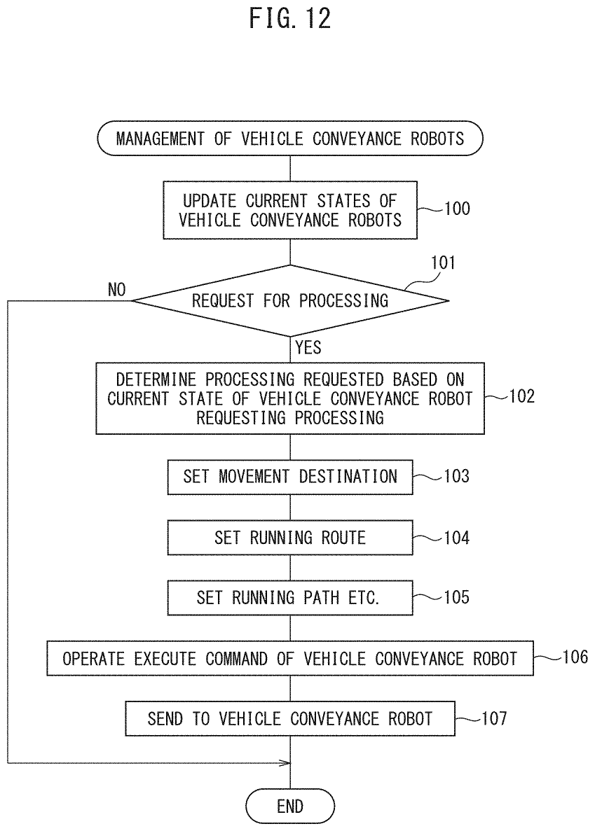

Now then, in the embodiment of the present invention, as explained later, a request for processing which the vehicle conveyance robot 11 should next perform is sent from the vehicle conveyance robot 11 to the lot entry/exit management server 13. If receiving the request for processing to next perform, the lot entry/exit management server 13 determines the processing to next perform based on the current state of the vehicle conveyance robot 11. The request for processing determined is sent to the vehicle conveyance robot 11 and an operation command is issued to the vehicle conveyance robot 11. In this way, in the embodiment of the present invention, the behavior of the vehicle conveyance robot 11 is managed by the lot entry/exit management server 13. The management routine for managing the vehicle conveyance robot 11 is shown in FIG. 12. This routine is repeatedly performed at the electronic control unit 20 of the lot entry/exit management server 13.

Referring to FIG. 12, first, at step 100, the current states of all of the vehicle conveyance robots 11 shown in FIG. 10 are updated based on the image signals captured by the infrastructure sensors 14 or the position information of the vehicle conveyance robots 11 received from the vehicle conveyance robots 11. Next, at step 101, it is judged if the request for processing which the vehicle conveyance robot 11 should next perform has been received from the vehicle conveyance robot 11. When it is judged that the request for processing which the vehicle conveyance robot 11 should next perform has not been received, the processing cycle is ended. As opposed to this, when it is judged that the request for processing which the vehicle conveyance robot 11 should next perform has been received, the routine proceeds to step 102.

At step 102, the request for processing with respect to the vehicle conveyance robot 11 is determined based on the current state of the vehicle conveyance robot 11 issuing the request for processing to next perform. For example, if explaining as an example the case where the request for processing to next perform is issued from the vehicle conveyance robot 11 when the manual driving vehicle 16 finishes being loaded at the passenger platform 9, at this time, the current state of the vehicle conveyance robot 11 is a state of stopping for processing for loading a vehicle at the passenger platform 9 shown by X₂ at FIG. 11. Therefore, at step 102, processing for making the vehicle conveyance robot 11 move to the empty parking space 5 and unloading the manual driving vehicle 16 from the vehicle conveyance robot 11 is determined as the request for next processing.

If the request for next processing with respect to the vehicle conveyance robot 11 is determined at step 102, at step 103, the movement destination of the vehicle conveyance robot 11 is set. In the above-mentioned example, the empty parking space 5 is set as the movement destination of the vehicle conveyance robot 11 from among the large number of parking spaces 5. If the movement destination is set, the routine proceeds to step 104 where the running route from the passenger platform 9 to the empty parking space 5 is set based on the map data of the parking lot region 4 stored in the memory 32. Next, at step 105, the running path and running speed of the vehicle conveyance robot 11 not contacting other vehicles or structures are determined. Next, at step 106, the operation execute command of the vehicle conveyance robot 11 is issued. Next, at step 107, the request for processing with respect to the vehicle conveyance robot 11 and the empty parking space 5, the running route, the running path, and the running speed which are set and the operation execute command are sent from the lot entry/exit management server 13 to the vehicle conveyance robot 11.

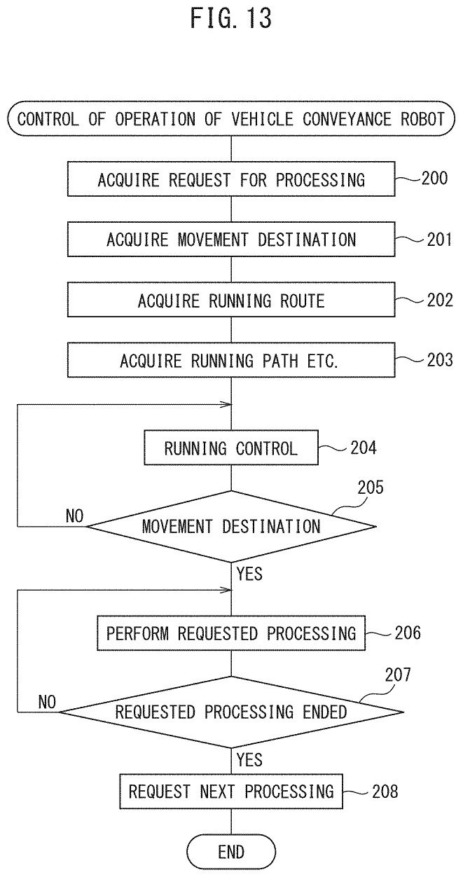

If the operation execute command is sent from the lot entry/exit management server 13 to the vehicle conveyance robot 11, control of automated driving of the vehicle conveyance robot 11 is started. FIG. 13 shows this routine for control of operation of the vehicle conveyance robot 11. This routine is repeatedly performed at the electronic control unit 60 mounted at the conveyance robot head 50 of the vehicle conveyance robot 11.

Referring to FIG. 13, first, at step 200, the request for processing with respect to the vehicle conveyance robot 11 determined at the lot entry/exit management server 13 is acquired. Next, at step 201, the movement destination set at the lot entry/exit management server 13 is acquired. Next, at step 202, the running route set at the lot entry/exit management server 13 is acquired. At step 203, the running path and the running speed set at the lot entry/exit management server 13 are acquired. Next, at step 204, control of running of the vehicle conveyance robot 11 is performed along the set running path without contacting other vehicles or pedestrians based on the results of detection of cameras capturing the front of the vehicle conveyance robot 11 etc., LIDAR, radar, or other periphery detection sensors. Next, at step 205, it is judged if the vehicle conveyance robot 11 reaches the movement destination, in the above-mentioned example, if the vehicle conveyance robot 11 reaches the set empty parking space 5. When it is judged that the automated driving vehicle 6 has not reached the movement destination, the routine returns to step 204 where the automated driving of the vehicle conveyance robot 11 is continued. On the other hand, if at step 205 it is judged that the vehicle conveyance robot 11 reaches the movement destination, the routine proceeds to step 206.

At step 206, the request for processing with respect to the vehicle conveyance robot 11 is performed. In the above-mentioned example, processing for unloading the manual driving vehicle 16 from the vehicle conveyance robot 11 is performed. That is, the bed part 51 is made to descend, and the carried manual driving vehicle 16 is lowered to the ground surface of the parking space 5. Next, all of the arms 55 are made to swing to the retracted positions. Next, the vehicle conveyance robot 11 is made to advance and, as shown in FIG. 8B, the bed part 51 is made to move to the running ready position where it is completely pulled out from under the manual driving vehicle 16. At step 207, it is judged if the request for processing with respect to the vehicle conveyance robot 11, in the above-mentioned example, the processing for unloading the manual driving vehicle 16 from the vehicle conveyance robot 11, has been completed, that is, if the bed part 51 has been made to move to the running ready position. When it is judged that the request for processing with respect to the vehicle conveyance robot 11 has not been completed, the routine returns to step 206 where the request for processing with respect to the vehicle conveyance robot 11 is continued. On the other hand, when at step 207 it is judged that the request for processing with respect to the vehicle conveyance robot 11 has been completed, the routine proceeds to step 208 where the request for processing which the vehicle conveyance robot 11 should next perform is sent to the lot exit management server 13.

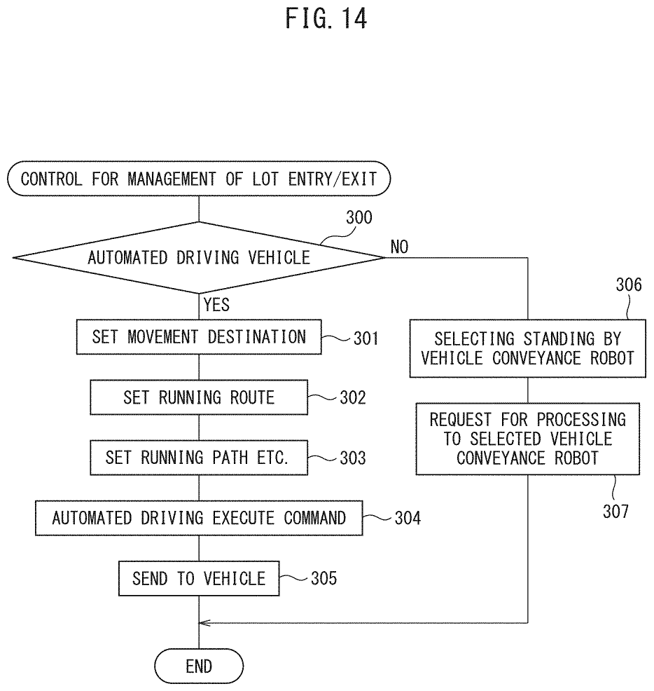

In this way, the vehicle conveyance robot 11 is controlled using the routine for management of a vehicle conveyance robot 11 shown in FIG. 12 and the routine for control of operation of a vehicle conveyance robot 11 shown in FIG. 13. Therefore, even where there is the request for lot entry/exit from the manual driving vehicle 16, the vehicle conveyance robot 11 is controlled using the routine for management of the vehicle conveyance robot 11 shown in FIG. 12 and the routine for control of operation of the vehicle conveyance robot 11 shown in FIG. 13. Therefore, next, referring to FIG. 14, the routine for control of lot entry/exit management performed at the electronic control unit 20 when the lot entry/exit management server 13 receives the request for lot entry/exit from the automated driving vehicle 15 or manual driving vehicle 16 will be explained.

Referring to FIG. 14, first, at step 300, it is judged if the vehicle requesting lot entry is the automated driving vehicle 15 or is the manual driving vehicle 16. When it is judged that the vehicle requesting lot entry is the automated driving vehicle 15, the routine proceeds to step 301 where the empty parking space 5 is set as the movement destination of the automated driving vehicle 15 among the large number of parking spaces 5. If the movement destination is set, the routine proceeds to step 302 where the running route from the passenger platform 9 to the empty parking space 5 is set based on the map data of the parking lot region 4 stored in the memory 32. Next, at step 303, the running path and the running speed of the automated driving vehicle 15 not contacting other vehicles or structures are determined. Next, at step 304, the automated operation execute command of the automated driving vehicle 15 is issued. Next, at step 305, the empty parking space 5, the running route, the running path, and the running speed which are set and the automated operation execute command are sent from the lot entry/exit management server 13 to the automated driving vehicle 15.

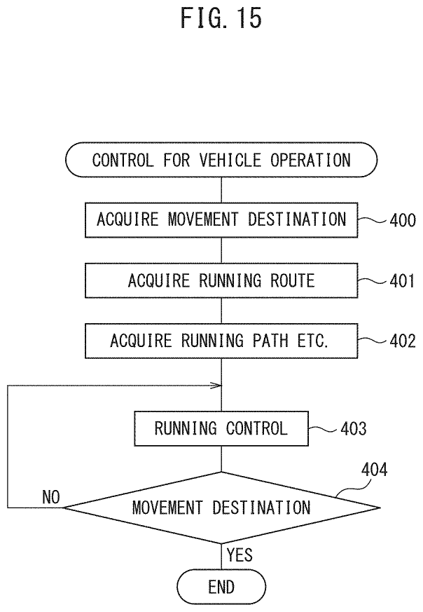

If the automated operation execute command is sent from the lot entry/exit management server 13 to the automated driving vehicle 15, control of automated driving of the automated driving vehicle 15 is started. FIG. 15 shows the vehicle operation control routine for control of operation of this automated driving vehicle 15. This routine is repeatedly performed at the electronic control unit 30 mounted in the automated driving vehicle 15.

Referring to FIG. 15, first, at step 400, the movement destination set at the lot entry/exit management server 13 is acquired. Next, at step 401, the running route set at the lot entry/exit management server 13 is acquired. At step 402, the running path and the running speed set at the lot entry/exit management server 13 are acquired. Next, at step 403, control for running of the automated driving vehicle 15 is performed along the set running path based on the results of detection of the cameras capturing the front of the vehicle conveyance robot 11 etc., the LIDAR, radar, or other periphery detection sensors so as not to contact other vehicles or pedestrians. Next, at step 404, it is judged if the automated driving vehicle 15 reaches the movement destination. When it is judged that the automated driving vehicle 15 has not reached the movement destination, the routine returns to step 403 where automated driving of the automated driving vehicle 15 is continued. On the other hand, when at step 404 it is judged that the automated driving vehicle 15 reaches the movement destination, that is, when parking to the empty parking space 5 has been completed, lot entry management is ended.

On the other hand, control for lot entry/exit management when the user desires lot exit of the automated driving vehicle 15 is also performed using the routine for lot entry/exit management shown in FIG. 14. However, in this case, at step 301 of FIG. 14, the passenger platform 9 is set as the movement destination of the automated driving vehicle 15, at step 302, the running route from the parking space 5 currently parked at to the passenger platform 9 is set, at step 303, the running path and the running speed of the automated driving vehicle 15 not contacting other vehicles or structures are set, at step 304, the automated operation execute command of the automated driving vehicle 15 is issued, and at step 305, the movement destination, the running route, the running path, and the running speed which are set and the automated operation execute command are sent from the lot entry/exit management server 13 to the automated driving vehicle 15. If the automated driving vehicle 15 receives the movement destination, the running route, the running path, and the running speed which are set and the automated operation execute command, processing for lot exit of the automated driving vehicle 15 is performed by the routine for control of operation of the automated driving vehicle 15 shown in FIG. 15.

On the other hand, when at step 300 of FIG. 14 it is judged that the vehicle requesting the lot entry/exit is the manual driving vehicle 16, the routine proceeds to step 306 where one vehicle conveyance robot 11 is selected from among the vehicle conveyance robots 11 standing by at the standby location 10. Next, at step 307, the request for processing with respect to the selected vehicle conveyance robot 11 is made. That is, when the manual driving vehicle 16 requests lot entry, the request for lot entry of the manual driving vehicle 16 is made. When the manual driving vehicle 16 requests lot exit, the request for lot exit of the manual driving vehicle 16 is made. In this case, when the manual driving vehicle 16 is requesting lot entry, at the routine for management of the vehicle conveyance robot 11 shown in FIG. 12, processing is performed for making the vehicle conveyance robot 11 move to the passenger platform 9 and loading the manual driving vehicle 16 on the vehicle conveyance robot 11, while when the manual driving vehicle 16 is requesting lot exit, processing is performed for making the vehicle conveyance robot 11 move to the manual driving vehicle 16 parked at the parking space 5 and load the manual driving vehicle 16 on the vehicle conveyance robot 11, then making the vehicle conveyance robot 11 move to the passenger platform 9 and unload the manual driving vehicle 16 from the vehicle conveyance robot 11.

In this regard, for example, when the automated driving vehicle 15 becomes disabled and stops due to a shortage of drive energy of the automated driving vehicle 15, it is preferable to convey the automated driving vehicle 15 by the vehicle conveyance robot 11 to a facility able to supply drive energy. When the automated driving vehicle 15 becomes disabled and stops due to trouble in vehicle equipment, it is preferable to tow the automated driving vehicle 15 by the automated towing robot 11 to a facility able to restore the vehicle functions. Therefore, in the embodiment of the present invention, when the automated driving vehicle becomes disabled and stops, the automated driving vehicle is made to be conveyed by the vehicle conveyance robot 11 to a facility having a function enabling the vehicle to be restored to a runnable state for the cause of disablement of the automated driving vehicle 15.

Next, the causes of disablement of the automated driving vehicle 15 will be explained. Now then, various energies are used to drive the automated driving vehicle 15. For example, if an internal combustion engine is being used as a drive source of the automated driving vehicle 15, the drive energy of the automated driving vehicle 15 is gasoline or another liquid fuel. If an electric motor is being used as a drive source of the automated driving vehicle 15, the drive energy of the automated driving vehicle 15 is the output of a battery or the output of a fuel cell. The cause of disablement of the automated driving vehicle 15 differs depending on the type of energy. In the electronic control unit 30 of the automated driving vehicle 15, work is performed to judge the cause of disablement of the automated driving vehicle 15 based on the detection signals from the various equipment 42.

For example, in the automated driving vehicle 15 using liquid fuel, the remaining amount of liquid fuel is constantly detected. When the remaining amount of liquid fuel becomes a preset lower limit value or less, the automated driving vehicle 15 becomes disabled and stops. At this time, the cause of disablement of the automated driving vehicle 15 is deemed a shortage of liquid fuel. On the other hand, in the automated driving vehicle 15 in which the automated driving vehicle 15 is driven by an electric motor and the electric motor is made to operate by the supply of electric power from a battery, the remaining charge of the battery is constantly detected. When the remaining charge of the battery becomes a preset lower limit value or less, the automated driving vehicle 15 becomes disabled and stops. At this time, the cause of disablement of the automated driving vehicle 15 is deemed a shortage of remaining charge of the battery. Further, in the automated driving vehicle 15 in which the automated driving vehicle 15 is driven by an electric motor and the electric motor is made to operate by the supply of electric power from a fuel cell, the remaining amount of hydrogen in the hydrogen tank is constantly detected. When the remaining amount of hydrogen becomes a preset lower limit value or less, the automated driving vehicle 15 becomes disabled and stops. At this time, the cause of disablement of the automated driving vehicle 15 is deemed a shortage of the remaining amount of hydrogen.

On the other hand, as a typical example of trouble in vehicle functions, a puncture of a tire of the automated driving vehicle 15 may be mentioned. In this case, if a tire is punctured and the air pressure inside the tire falls, the rotational speed of the tire will change. Therefore, it is possible to detect the puncture of the tire from a change of the rotational speed of the tire. Therefore, in the embodiment of the present invention, a change of the rotational speed of the tire is constantly detected and whether the tire has been punctured is constantly judged based on the change of rotational speed of the tire. When it is judged that the tire of the automated driving vehicle 15 has been punctured, if the automated driving vehicle 15 becomes disabled and stops, the cause of disablement of the automated driving vehicle 15 is deemed the puncture of the tire.

Next, the facilities having functions enabling a vehicle to be restored to a runnable state for these causes of disablement will be explained. When the automated driving vehicle 15 stops due to a shortage of gasoline or other liquid fuel, the automated driving vehicle 15 can run by being supplied with liquid fuel. Therefore, when the cause of disablement of the automated driving vehicle 15 is deemed a shortage of liquid fuel, the facility having a function enabling a vehicle to be restored to a runnable state for the cause of disablement is a gas station. Further, when the automated driving vehicle 15 stops due to a shortage of the remaining charge of a battery, the automated driving vehicle 15 can run by charging the battery. Therefore, when the cause of disablement of the automated driving vehicle 15 is deemed a shortage of the remaining charge of the battery, the facility having a function enabling a vehicle to be restored to a runnable state for the cause of disablement is a charging station.

On the other hand, when the automated driving vehicle 15 stops due to a shortage of a remaining amount of hydrogen, the automated driving vehicle 15 can run by being supplied with hydrogen. Therefore, when the cause of disablement of the automated driving vehicle 15 is deemed a shortage of the remaining amount of hydrogen, the facility having a function enabling a vehicle to be restored to a runnable state for the cause of disablement is a hydrogen station. Further, when an automated driving vehicle 15 stops due to a puncture of a tire, the automated driving vehicle 15 can run by replacement of the tire or repair of the tire. Therefore, when the cause of disablement of the automated driving vehicle 15 is deemed the puncture of the tire, the facility having a function enabling a vehicle to be restored to a runnable state for the cause of disablement is a repair shop or other repair facility.

In the embodiment of the present invention, work for judgment of the cause of disablement of an automated driving vehicle 15 is performed at the automated driving vehicle 15. When the automated driving vehicle 15 becomes disabled and stops, a facility having a function enabling a vehicle to be restored to a runnable state for the judged cause of disablement, that is, one of the gas station, charging station, hydrogen station, and repair facility, is selected and the disabled automated driving vehicle 15 is conveyed by the vehicle conveyance robot 11 to the selected facility.

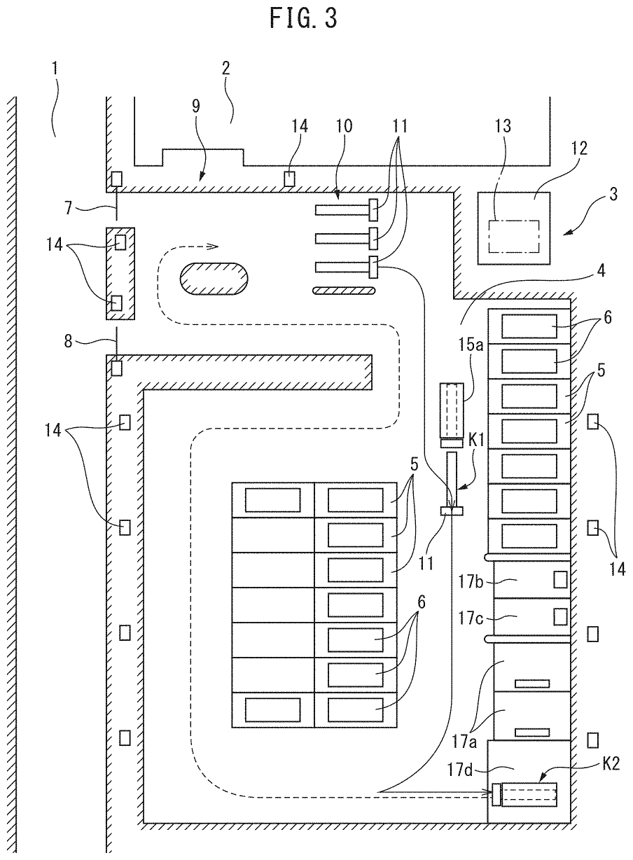

That is, in the embodiment of the present invention, as shown in FIG. 1 to FIG. 3, the automated parking lot 3 is provided inside it with a gas station 17a, charging station 17b, hydrogen station 17c, and repair facility 17d. When the automated driving vehicle 15 becomes disabled and stops inside the automated parking lot 3, the facility having a function enabling a vehicle to be restored to a runnable state for the cause of disablement of the automated driving vehicle 15, that is, one of the gas station 17a, charging station 17b, hydrogen station 17c, and repair facility 17d, is selected and the disabled automated driving vehicle 15 is conveyed by the vehicle conveyance robot 11 to the selected facility. FIG. 3 schematically shows a typical example of such work for conveyance of a disabled automated driving vehicle 15 by the vehicle conveyance robot 11. Note that, in this example, the case where the disabled automated driving vehicle 15 is conveyed by the vehicle conveyance robot 11 to the repair facility 17d is shown.

In FIG. 3, 15a shows the automated driving vehicle which has become disabled and stops inside the parking lot region 4. Below, the automated driving vehicle 15a which has become disabled and stops will be referred to as a “disabled vehicle 15a”. In the embodiment of the present invention, when the automated driving vehicle 15 has become disabled and stops, one of the vehicle conveyance robots 11 standing by at the standby location 10 is issued a request for conveyance of the disabled vehicle 15a. If the vehicle conveyance robot 11 is issued a request for conveyance of the disabled vehicle 15a, the vehicle conveyance robot 11, as shown by the solid arrow, is made to move from the standby location 10 to the vehicle loading ready position K1 of the disabled vehicle 15a (FIG. 7A), then work for loading the disabled vehicle 15a on the vehicle conveyance robot 11 is performed.

Next, the vehicle conveyance robot 11 carrying the disabled vehicle 15a is made to move to the predesignated location shown by K2 in the repair facility 17d and the disabled vehicle 15a is unloaded from the vehicle conveyance robot 11 to the predesignated location K2. Next, the empty vehicle conveyance robot 11 is returned to the standby location 10 as shown by the broken arrow.

To perform such conveyance work of the disabled vehicle 15a, as shown in the list of FIG. 11, the current states Zi of the vehicle conveyance robot 11 are preset even for the time of occurrence of the disabled vehicle. As shown in FIG. 11, at the time of occurrence of the disabled vehicle, R₀ shows the state of standing by at the standby location 10, Z₁ shows a state of running toward the vehicle loading ready position of the disabled vehicle 15a (FIG. 7A), Z₂ shows a state of stopping for processing for loading the disabled vehicle 15a, Z₃ shows a state of running toward the vehicle unloading position of the selected facility, Z₄ shows a state of stopping for processing for unloading the vehicle at the selected facility, and Z₅ shows a state of running for return to the standby location 10.

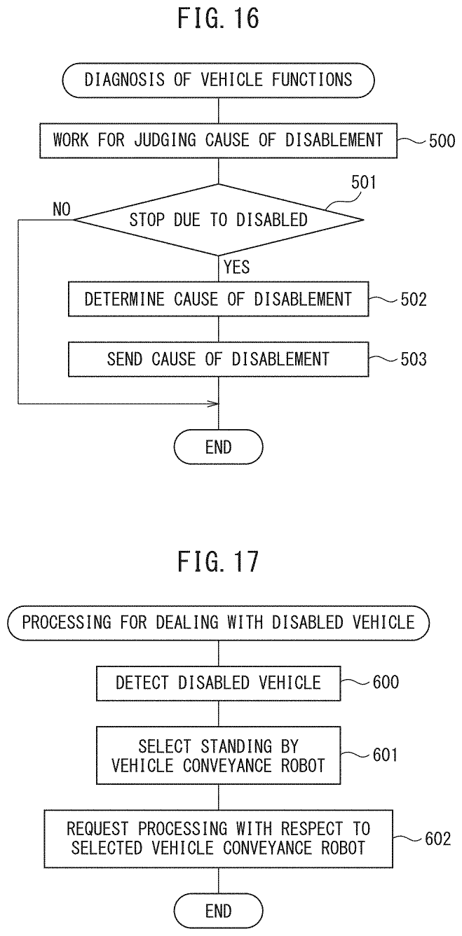

FIG. 16 shows a routine for diagnosis of vehicle functions of an automated driving vehicle 15. This routine is repeatedly performed at the electronic control unit 30 of the automated driving vehicle 15.

Referring to FIG. 16, first, at step 500, work for judgment of the cause of disablement of the automated driving vehicle 15 is performed based on the detected value of the remaining amount of liquid fuel, the detected value of the remaining charge of the battery, the detected value of the remaining amount of hydrogen, and the detected value of a change in rotational speed of the tires. Next, at step 501, it is judged whether the automated driving vehicle 15 has become disabled and stops. When the automated driving vehicle 15 has not stopped or when the automated driving vehicle 15 stops for a reason other than being disabled, the processing cycle is ended. As opposed to this, when it is judged that the automated driving vehicle 15 has become disabled and stops, the routine proceeds to step 502. At step 502, the cause of disablement of the automated driving vehicle 15 is determined based on the result of judgment of the work of judgment of the cause of disablement of the automated driving vehicle 15 performed at step 500. Next, at step 502, the determined cause of disablement and vehicle ID are sent to the lot entry/exit management server 13.

FIG. 17 shows a routine for processing for dealing with the disabled vehicle for performing the work of conveyance of the disabled vehicle. This routine is repeatedly performed at the electronic control unit 20 of the lot entry/exit management server 13.

Referring to FIG. 17, first, at step 600, the disabled vehicle 15a present in the automated parking lot 3 is detected. The disabled vehicle 15a is detected based on disabled information of the automated driving vehicle 15 sent from the automated driving vehicle 15 to the lot entry/exit management server 13 or the image signals captured by the infrastructure sensors 14. Next, at step 601, one vehicle conveyance robot 11 is selected from among the vehicle conveyance robots 11 standing by at the standby location 10. Next, at step 602, a request for processing with respect to the selected vehicle conveyance robot 11, that is, a request for conveyance of the disabled vehicle 15a by the selected vehicle conveyance robot 11, is issued.

If the request for conveyance of the disabled vehicle 15a by the selected vehicle conveyance robot 11 is issued, various commands are issued to the selected vehicle conveyance robot 11 for conveying the disabled vehicle 15a by the management routine of the vehicle conveyance robot shown in FIG. 12. Operation of the vehicle conveyance robot 11 is controlled by the routine for control of operation of the vehicle conveyance robot 11 shown in FIG. 13.

That is, if the request for conveyance of the disabled vehicle 15a by the selected vehicle conveyance robot 11 is issued, it is judged that there was the request for processing for conveyance of the disabled vehicle 15a at step 101 of the routine for management of the vehicle conveyance robot shown in FIG. 12 and the routine proceeds to step 102. At step 102, the request for processing with respect to the vehicle conveyance robot 11 is determined based on the set current state of the vehicle conveyance robot 11. When there was the request for processing for conveyance of the disabled vehicle 15a, the current state of the vehicle conveyance robot 11 is a state of standing by at the standby location 10 shown by R₀ in FIG. 11. Therefore, at step 102, processing for making the vehicle conveyance robot 11 move from the standby location 10 to the loading ready position K1 of the disabled vehicle 15a (FIG. 3) to load the disabled vehicle 15a on the vehicle conveyance robot 11 is determined as the request for next processing.

If at step 102 the request for next processing with respect to the vehicle conveyance robot 11 is determined, at step 103, the movement destination of the vehicle conveyance robot 11 is set. At this time, the loading ready position K1 of the disabled vehicle 15a (FIG. 3) is set as the movement destination of the vehicle conveyance robot 11. If the movement destination is set, the routine proceeds to step 104 where the running route from the standby location 10 to the loading ready position K1 (FIG. 3) is set based the map data of the parking lot region 4 stored in the memory 32. Next, at step 105, the running path and the running speed of the vehicle conveyance robot 11 not contacting other vehicles or structures are determined. Next, at step 106, the operation execute command of the vehicle conveyance robot 11 is issued. Next, at step 107, the request for processing with respect to the vehicle conveyance robot 11, the loading ready position K1, the running route, the running path, the running speed and the operation execute command are sent from the lot entry/exit management server 13 to the vehicle conveyance robot 11.

If the operation execute command is sent from the lot entry/exit management server 13 to the vehicle conveyance robot 11, the routine for control of operation of the vehicle conveyance robot 11 shown in FIG. 13 is performed and work for conveyance of the disabled vehicle 15a by the vehicle conveyance robot 11 is started. That is, referring to FIG. 13, first, at step 200, the request for processing with respect to the vehicle conveyance robot 11 determined at the lot entry/exit management server 13, that is, the request for conveyance of the disabled vehicle 15a, is acquired. Next, at step 201, the movement destination set at the lot entry/exit management server 13, that is, the loading ready position K1 (FIG. 3), is acquired. Next, at step 202, the running route set at the lot entry/exit management server 13 is acquired while at step 203, the running path and the running speed set at the lot entry/exit management server 13 are acquired.

Next, at step 204, control of running of the vehicle conveyance robot 11 is performed along the set running path without contacting other vehicles or pedestrians based on the results of detection of cameras capturing the front etc. of the vehicle conveyance robot 11, LIDAR, radar, or other periphery detection sensors. Next, at step 205, it is judged if the vehicle conveyance robot 11 reaches the movement destination, that is, the loading ready position K1. When it is judged that the vehicle conveyance robot 11 has not reached the movement destination, that is, the loading ready position K1, the routine returns to step 204 where automated driving of the vehicle conveyance robot 11 is continued. On the other hand, when at step 205 it is judged that the vehicle conveyance robot 11 reaches the movement destination, that is, the loading ready position K1, the routine proceeds to step 206.

At step 206, the request for processing with respect to the vehicle conveyance robot 11, that is, processing for loading the disabled vehicle 15a on the vehicle conveyance robot 11, is performed. That is, the vehicle conveyance robot 11 is made to retract and the bed part 51 is made to enter below the disabled vehicle 15a. Next, all of the arms 55 are made to swing to the projected positions, then the bed part 51 is made to rise. If the bed part 51 is made to rise, all of the wheels of the disabled vehicle 15a are supported by the corresponding pairs of arms 55. Due to this, the disabled vehicle 15a is loaded on the vehicle conveyance robot 11. At step 207, it is judged if the request for processing with respect to the vehicle conveyance robot 11, that is, the processing for loading the disabled vehicle 15a on the vehicle conveyance robot 11, has been completed. When it is judged that the request for processing with respect to the vehicle conveyance robot 11 has not been completed, the routine returns to step 206 where the request for processing with respect to the vehicle conveyance robot 11 is continued. On the other hand, when at step 207 it is judged that the request for processing with respect to the vehicle conveyance robot 11 has been completed, the routine proceeds to step 208 where the request for processing which the vehicle conveyance robot 11 should next performed is sent to the lot entry/exit management server 13.

If the lot entry/exit management server 13 receives the request for processing which the vehicle conveyance robot 11 should next perform, at step 101 of the routine for management of vehicle conveyance robots shown in FIG. 12, it is judged that there is the request for processing which the vehicle conveyance robot 11 should next perform and the routine proceeds to step 102. At step 102, the request for processing with respect to the vehicle conveyance robot 11 is determined based on the current state of the vehicle conveyance robot 11 issuing the request of the processing to next perform. At this time, the current state of the vehicle conveyance robot 11 is the state of stopping for processing for loading the disabled vehicle 15a shown by Z₂ in FIG. 11. Therefore, at step 102, processing for making the conveyance robot 11 carrying the disabled vehicle 15a move to the next destination to unload the disabled vehicle 15a from the vehicle conveyance robot 11 is determined as the request for next processing.

If at step 102 the request for next processing with respect to the vehicle conveyance robot 11 is determined, at step 103, the facility having a function enabling a vehicle to be restored to a runnable state is selected for the cause of disablement from among the gas station 17a, charging station 17b, hydrogen station 17c, and repair facility 17d based on the cause of disablement of the automated driving vehicle 15 received from the disabled vehicle 15a. Then, the predesignated location in the selected facility is set as the movement destination of the vehicle conveyance robot 11. In this case, in the example shown in FIG. 3, the case where the predesignated location K2 in the repair facility 17d is selected as the facility having a function enabling the vehicle to be restored to a runnable state for the cause of disablement of the automated driving vehicle 15 is shown.

Now then, if at step 103, for example, the predesignated location in the repair facility 17d is set as the movement destination of the vehicle conveyance robot 11, the routine proceeds to step 104 where the running route from the current position to the predesignated location in the repair facility 17d is set based on the map data of the parking lot region 4 stored in the memory 32. Next, at step 105, the running path and the running speed of the vehicle conveyance robot 11 not contacting other vehicles or structures are determined. Next, at step 106, the operation execute command of the vehicle conveyance robot 11 is issued. Next, at step 107, the request for processing with respect to the vehicle conveyance robot 11, the movement destination, that is, the predesignated location in the repair facility 17d, the running route, the running path, the running speed, and the operation execute command are sent from the lot entry/exit management server 13 to the vehicle conveyance robot 11.

If the operation execute command is sent from the lot entry/exit management server 13 to the vehicle conveyance robot 11, the routine for control of the operation of the vehicle conveyance robot 11 shown in FIG. 13 is performed and processing for making the vehicle conveyance robot 11 carrying the disabled vehicle 15a move to the predesignated location in the repair facility 17d to unload the disabled vehicle 15a from the vehicle conveyance robot 11 is started. That is, referring to FIG. 13, first, at step 200, the request for processing with respect to the vehicle conveyance robot 11 determined at the lot entry/exit management server 13, that is, the request for processing for making the vehicle conveyance robot 11 carrying the disabled vehicle 15a move to the predesignated location in the repair facility 17d and unload the disabled vehicle 15a from the vehicle conveyance robot 11, is acquired. Next, at step 201, the movement destination set at the lot entry/exit management server 13, that is, the predesignated location in the repair facility 17d, is acquired. Next, at step 202, the running route set at the lot entry/exit management server 13 is acquired, while at step 203, the running path and the running speed set at the lot entry/exit management server 13 are acquired.

Next, at step 204, control of running of the vehicle conveyance robot 11 is performed along the set running path without contacting other vehicles or pedestrians based on the results of detection of cameras capturing the front etc. of the vehicle conveyance robot 11, LIDAR, radar, or other periphery detection sensors. Next, at step 205, it is judged if the vehicle conveyance robot 11 reaches the movement destination, that is, the predesignated location inside the repair facility 17d. When it is judged that the vehicle conveyance robot 11 has not reached the movement destination, that is, the predesignated location inside the repair facility 17d, the routine returns to step 204 where automated driving of the vehicle conveyance robot 11 is continued. On the other hand, when at step 205 it is judged that the vehicle conveyance robot 11 reaches the movement destination, that is, the predesignated location inside the repair facility 17d, the routine proceeds to step 206.

At step 206, the request for processing with respect to the vehicle conveyance robot 11, that is, processing for unloading the disabled vehicle 15a from the vehicle conveyance robot 11 at the repair facility 17d, is performed. That is, the bed part 51 is made to descend, and the carried disabled vehicle 15a is lowered on the ground surface of the predesignated location in the repair facility 17d. Next, all of the arms 55 are swung to the retracted positions. Next, the vehicle conveyance robot 11 is made to advance and is made to move to the running ready position where the bed part 51 is completely pulled out from below the manual driving vehicle 16. At step 207, it is judged if the request for processing with respect to the vehicle conveyance robot 11, that is, processing for unloading the disabled vehicle 15a from the vehicle conveyance robot 11, is completed. When it is judged that the request for processing with respect to the vehicle conveyance robot 11 has not been completed, the routine returns to step 206 where the request for processing with respect to the vehicle conveyance robot 11 is continued. On the other hand, when at step 207 it is judged that the request for processing with respect to the vehicle conveyance robot 11 has been completed, the routine proceeds to step 208 where the request for processing which the vehicle conveyance robot 11 should next perform is sent to the lot entry/exit management server 13.

Next, the processing to next perform of the vehicle conveyance robot 11 is performed. In this case, in the example shown in FIG. 3, as shown by the broken line in FIG. 3, the processing for making the vehicle conveyance robot 11 return to the standby location 10 is made the processing to next perform.

Note that, the work for conveyance of the disabled vehicle 15a by the vehicle conveyance robot 11 explained up to now can also be applied to the case of conveying a vehicle which has become disabled on a general road by a vehicle conveyance robot 11.

Therefore, in the embodiment of the present invention, the vehicle conveyance management system is comprised of the vehicle conveyance robot 11 which is automatically driven for conveying the vehicle, the management server 13 for managing operation of the vehicle conveyance robot, and a plurality of facilities 17a, 17b, 17c, 17d having respectively different functions enabling the vehicle to be restored to a runnable state in accordance with a cause of disablement when the vehicle becomes disabled and stops. The cause of disablement when the vehicle becomes disabled and stops is acquired by the management server 13, a facility having a function enabling the vehicle to be restored to a runnable state for the acquired cause of disablement is selected from the plurality of facilities 17a, 17b, 17c, 17d, and the disabled vehicle is conveyed by the vehicle conveyance robot 11 to the selected facility.

Further, in the embodiment of the present invention, there is provided a vehicle conveyance management method comprising preparing a plurality of facilities 17a, 17b, 17c, 17d having respectively different functions enabling the vehicle to be restored to a runnable state in accordance with a cause of disablement when the vehicle becomes disabled and stops, acquiring the cause of disablement when the vehicle becomes disabled and stops, selecting a facility having a function enabling the vehicle to be restored to a runnable state for the acquired cause of disablement from the plurality of facilities 17a, 17b, 17c, 17d, and making the disabled vehicle be conveyed by the vehicle conveyance robot 11 to the selected facility.

Further, in the embodiment of the present invention, there is provided a non-transitory computer-readable storage medium storing a program used for control of the vehicle conveyance management system comprising a plurality of facilities 17a, 17b, 17c, 17d having respectively different functions enabling the vehicle to be restored to a runnable state in accordance with a cause of disablement when the vehicle becomes disabled and stops. This program causes a computer to acquire the cause of disablement when the vehicle becomes disabled and stops, select a facility having a function enabling the vehicle to be restored to a runnable state for the acquired cause of disablement from the plurality of facilities 17a, 17b, 17c, 17d, and make the disabled vehicle be conveyed by the vehicle conveyance robot 11 to the selected facility.

Further, in the embodiment of the present invention, the causes of disablement include a shortage of drive energy of the vehicle and trouble in vehicle equipment, and the facilities 17a, 17b, 17c, and 17d include a facility having a function enabling shortage of drive energy to be eliminated to restore the vehicle to the runnable state and a facility having a function enabling trouble in vehicle equipment to be eliminated to restore the vehicle to the runnable state. In this case, the shortage of drive energy of the vehicle is a shortage of liquid fuel and the facility having a function enabling a shortage of drive energy to be eliminated to restore the vehicle to the runnable state is a gas station 17a. Alternatively, in this case, the shortage of drive energy of the vehicle is a shortage of hydrogen fuel and the facility having a function enabling a shortage of drive energy to be eliminated to restore the vehicle to the runnable state is a hydrogen station 17c. Alternatively, in this case, the shortage of drive energy of the vehicle is a shortage of charging of a battery and the facility having a function enabling a shortage of drive energy to be eliminated to restore the vehicle to the runnable state is a charging station 17b. Alternatively, in this case, the trouble in vehicle equipment is the puncture of the tire of the wheels and the facility having a function enabling trouble in vehicle equipment to be eliminated to restore the vehicle to the runnable state is a repair facility 17d. Alternatively, in this case, work for judgment of the cause of disablement of the vehicle is performed at the vehicle and the cause of disablement of the vehicle obtained as a result of the judgment work is sent to the management server 13.

Furthermore, in the embodiment of the present invention, lot entry/exit management of the automated parking lot 3 in which the manual driving vehicle 15 and automated driving vehicle 16 can park is performed by the management server 13, at the time of entry into the automated parking lot 3, the automated driving vehicle 15 is made to move to the set parking space 5 by automated driving and the manual driving vehicle 6 is conveyed to the set parking space 5 by the vehicle conveyance robot 11. When the automated driving vehicle 15 becomes disabled and stops in the automated parking lot 3, the cause of disablement is acquired by the management server 13, a facility having a function enabling the automated driving vehicle 15 to be restored to the runnable state for the acquired cause of disablement is selected from the plurality of facilities 17a, 17b, 17c, and 17d, and the disabled automated driving vehicle 15a is conveyed by the vehicle conveyance robot 11 to the selected facility.

In this case, when the automated driving vehicle 15 becomes disabled and stops in the automated parking lot 3, the vehicle conveyance robot 11 is made to move toward the disabled automated driving vehicle 15a, then the disabled automated driving vehicle 15a is loaded on the vehicle conveyance robot 11, the vehicle conveyance robot 11 carrying the disabled automated driving vehicle 15a is made to move to the selected facility, and, at the selected facility, the disabled automated driving vehicle 15a is unloaded from the vehicle conveyance robot 11.

What is claimed is:

1. A vehicle conveyance management system comprising:
a vehicle conveyance robot which is automatically driven for conveying a vehicle,
a management server for managing operation of the vehicle conveyance robot, and
a plurality of facilities having respectively different functions enabling a vehicle to be restored to a runnable state in accordance with a cause of disablement when the vehicle becomes disabled and stops, wherein
when the vehicle becomes disabled and stops, the cause of disablement is acquired by the management server, the facility having a function enabling the vehicle to be restored to a runnable state for the acquired cause of disablement is selected from the plurality of facilities, and the disabled vehicle is conveyed by the vehicle conveyance robot to the selected facility.

2. The vehicle conveyance management system according to claim 1, wherein causes of disablement include a shortage of drive energy of the vehicle and trouble in vehicle equipment and the facilities include a facility having a function enabling shortage of drive energy to be eliminated to restore the vehicle to the runnable state and a facility having a function enabling trouble in vehicle equipment to be eliminated to restore the vehicle to the runnable state.

3. The vehicle conveyance management system according to claim 2, wherein the shortage of drive energy of the vehicle is a shortage of liquid fuel and the facility having a function enabling a shortage of drive energy to be eliminated to restore the vehicle to the runnable state is a gas station.

4. The vehicle conveyance management system according to claim 2, wherein the shortage of drive energy of the vehicle is a shortage of hydrogen fuel and the facility having a function enabling a shortage of drive energy to be eliminated to restore the vehicle to the runnable state is a hydrogen station.

5. The vehicle conveyance management system according to claim 2, wherein the shortage of drive energy of the vehicle is a shortage of charging of a battery and the facility having a function enabling a shortage of drive energy to be eliminated to restore the vehicle to the runnable state is a charging station.

6. The vehicle conveyance management system according to claim 2, wherein the trouble in vehicle equipment is a puncture of a tire of the wheels and the facility having a function enabling trouble in vehicle equipment to be eliminated to restore the vehicle to the runnable state is a repair facility.

7. The vehicle conveyance management system according to claim 1, wherein lot entry/exit management of an automated parking lot in which a manual driving vehicle and automated driving vehicle can park is performed by the management server, at the time of entry into the automated parking lot, the automated driving vehicle is made to move to a set parking space by automated driving and the manual driving vehicle is conveyed to the set parking space by the vehicle conveyance robot, when the automated driving vehicle becomes disabled and stops in the automated parking lot, the cause of disablement is acquired by the management server, a facility having a function enabling the automated driving vehicle to be restored to the runnable state for the acquired cause of disablement is selected from the plurality of facilities, and the disabled automated driving vehicle is conveyed by the vehicle conveyance robot to the selected facility.

8. The vehicle conveyance management system according to claim 7, wherein when the automated driving vehicle becomes disabled and stops in the automated parking lot, the vehicle conveyance robot is made to move toward the disabled automated driving vehicle, then the disabled automated driving vehicle is loaded on the vehicle conveyance robot, the vehicle conveyance robot carrying the disabled automated driving vehicle is made to move to the selected facility, and, at the selected facility, the disabled automated driving vehicle is unloaded from the vehicle conveyance robot.

9. The vehicle conveyance management system according to claim 1, wherein work for judgment of the cause of disablement of the vehicle is performed at the vehicle and the cause of disablement of the vehicle obtained as a result of the judgment work is sent to the management server.

10. A vehicle conveyance management method comprising:
preparing a plurality of facilities having respectively different functions enabling a vehicle to be restored to a runnable state in accordance with a cause of disablement when the vehicle becomes disabled and stops,
acquiring the cause of disablement when the vehicle becomes disabled and stops,
selecting a facility having a function enabling the vehicle to be restored to a runnable state for the acquired cause of disablement from the plurality of facilities, and
making the disabled vehicle be conveyed by a vehicle conveyance robot to the selected facility.

11. A non-transitory computer-readable storage medium storing a program used for control of a vehicle conveyance management system comprising a plurality of facilities having respectively different functions enabling a vehicle to be restored to a runnable state in accordance with a cause of disablement when a vehicle becomes disabled and stops, said program causing a computer to:
acquire the cause of disablement when a vehicle becomes disabled and stops,
select a facility having a function enabling the vehicle to be restored to a runnable state for the acquired cause of disablement from the plurality of facilities, and
make the disabled vehicle be conveyed by a vehicle conveyance robot to the selected facility.
